(19) United States
(12) Patent Application Publication
(10) Pub. No.: US 2010/0262480 A1
(43) Pub. Date: Oct. 14, 2010

(54) System and method for presenting information over time to a user

(76) Inventor: Jeremy Beard, Western Australia (AU)

Correspondence Address: HARNESS, DICKEY & PIERCE, P.L.C., P.O. BOX 8910, RESTON, VA, 20195, US

(21) Appl. No.: 12/801,116

(22) Filed: May 24, 2010

Related U.S. Application Data
(63) Continuation of application No. 10/257,450, filed on Mar. 10, 2003, now abandoned.

(30) Foreign Application Priority Data
Apr. 11, 2000 (AU) PQ6831

(51) Int. Cl. G06Q 30/00; G06Q 10/00; G06F 3/048

(52) U.S. Cl. 705/14.19; 705/14.44; 715/809

(57) ABSTRACT

A system and method for presenting information over time to a user over a computer network (12), in which a server (14) stores presentation information (22) and control information (24). The user's computer (10) is responsive to the presentation information (22) and the control information (24), to produce a presentation which includes at least one prompt to the user at at least one randomly determined point during the presentation and to deliver the presentation to the user. The computer (10) also communicates to the server (14) whether the user provided a desired response within a predefined period during and/or after each prompt, following which the server (14) credits the user with having watched the information.

### PRIORITY STATEMENT

This application is a continuation of U.S. patent application Ser. No. 10/257,450 which completed entry into the National Stage on Mar. 10, 2003, which claims priority from the PCT Application No. PCT/AU01/00412 filed Apr. 11, 2001, which claims priority to Australian Application No. PQ6831 filed Apr. 11, 2000, the contents of each of which are incorporated by reference in their entirety.

### FIELD OF THE INVENTION

This invention relates to a method and system for presenting information over time to a user and for determining whether the user is paying attention to said information. The invention has particular, although not exclusive, utility in relation to the presentation of advertising information over a network of computers, such as the Internet.

### BACKGROUND ART

The growing use of the Internet for commercial purposes has seen a corresponding increase in the use of this medium for advertising.

Initially, advertising took the form of graphical images embedded into an Internet page. Such images are commonly referred to as banners. Since these banners are embedded into the page, they can be lost from sight when the user scrolls the page. Accordingly, such banner advertising can have limited effect.

In an attempt to ensure that users will read the advertising, some Internet pages create separate displays in which advertising material is presented. This separate display generally appears in front of other information, forcing the user to read the advertising information. However, many users find this form of advertising irritating and tend to close the separate display, thereby removing the advertising information altogether.

More recently, reward or incentive-based advertising has become popular on the Internet.

One example of reward or incentive-based advertising is offered by the company All Advantage where a separate portion of the user's display that is dedicated to the presentation of advertising information. The user is credited for the volume of advertisements or time spent during which the advertising information is visible. Since the separate display portion does not obstruct the user's viewing of other Internet pages, this form of advertising can be less irritating to a user.

Another example is U.S. Pat. No 5,794,210, issued to Goldhaber, et al. on Aug. 11, 1998, that describes an approach for rewarding users for watching an advertisement. In Goldhaber, a ‘cybercoin’ icon is used to signify that a reward is available, and the user commences the advertisement by pressing that cybercoin icon. On every occasion, the user is rewarded for commencing the advertisement. A database is used to track which advertisements have been previously selected by that user, to prevent the rewards being provided for the same advertisement. Goldhaber raises the possibility of providing a quiz after the advertisement to ensure they were paying attention. However, that quiz, depending on the level of difficulty, may be susceptible to being guessed, or otherwise known to the user in advance. Further, it may be a detail that the user missed or does not remember.

A further example is disclosed in U.S. Pub. No. 2005/0097594 A1 by O'Donnell et al., a continuation of an application filed Oct. 25 1999, which describes a system for promoting television programming, and for selectively delivering advertisements. There are several methods disclosed. A first method displays advertisements on a remote control display based on what the user is currently watching. In this method, the programming content of the television need not be interrupted whilst the advertisements are presented.

A second method disclosed in O'Donnell is the use of a ‘watch-and-win’ prompt, whereby an icon is displayed on the remote control next to items in the program guide, to indicate to the user that if they select and remain on the channel indicated, a reward will be provided. The ‘watch-and-win’ prompt is illustrated in FIG. 3 of O'Donnell, where a ‘W’ appears in the program guide next to the show name on the remote control, serving as an indicator that a reward is available for watching that show.

Reference is also made to U.S. Pat. No. 6,339,438, issued to Bates et al., on Jan. 15, 2002, where an advertisement is randomly selected for display in the scroll-bar of a computer window. After a period of time and/or expiration of a timer, a new advertisement may be displayed in the computer window.

However, the systems described suffer from several disadvantages.

Firstly, there is no guarantee that the user is watching the advertisements or programs. Thus, the user may access rewards or incentives without having watched the advertisement or program. For example, the user could have left the room or diverted their attention elsewhere.

Secondly, there is capacity for the user to waste their valuable time by unknowingly making a mistake whilst watching a program, and continuing to watch that program despite the incentive or reward no longer being available. For example, if the user were to watch a long advertisement and answer a quiz question afterwards as considered in Goldhaber, they may only at that point discover that they had overlooked a detail that formed the subject matter of the quiz. Therefore, the user's time may be wasted, and the user may be prone to experience a degree of frustration in connection with the same.

### DISCLOSURE OF THE INVENTION

In accordance with a second aspect of this invention, there is provided a system for presenting information over time to a user, comprising a processor arranged to store presentation information and control information; a user display appliance responsive to the presentation information to produce a presentation and deliver the presentation over time to the user; said user display appliance further responsive to the control information to visually present at least one prompt to the user at at least one point in time during the presentation; said user display appliance arranged to communicate to the processor whether a desired response, in response to the prompt, was received from the user within a predefined period during and/or after each prompt; said processor arranged to credit the user with having paid attention to the presentation over time upon being notified by the user display appliance that the desired response, in response to the prompt, was received within the predefined period; and wherein said user display appliance arranged to notify the user that they did not comply with the requirements to be credited with having paid attention to the advertisement upon the user display appliance determining that the desired response was not received from the user within the predefined period.

Preferably, the at least one prompt is presented at a random point in time during the presentation, and the random point in time is determined based on a random number generator included in the control information.

In accordance with a second aspect of this invention, there is provided a computer-readable medium having computer software stored thereon, the computer software arranged, when executed in a computer to perform method steps for presenting information over time to a user on a user display appliance, the method steps comprising: presenting said information over time to the user on the user display appliance; presenting a visual prompt to the user on the user display appliance at at least one point in time during the presentation of said information; determining whether a desired response, in response to each prompt, is received from the user within a predefined period during and/or after each prompt; crediting the user with having paid attention to the information only if the user provides all desired responses, in response to the prompt; and notifying the user that they did not comply with the requirements to be credited with having paid attention to the advertisement if a desired response is not received from the user within the predefined period during and/or after each prompt.

In accordance with a third aspect of the present invention, there is provided a computer-implemented method for ensuring that a user pays attention to an advertisement, the method comprising the steps of receiving, at a user computer, presentation information and control information, the presentation information including the advertisement; presenting the advertisement to the user at the user computer in accordance with the presentation information; at the user computer and in accordance with the control information, outputting at least one visual prompt during the presentation of the advertisement to the user; at the user computer, enabling the user to respond to the at least one prompt within a predefined period while the advertisement is presented to the user to signify that the user paid attention to the advertisement; communicating the response of the user, in response to the prompt, to a remote server; and notifying the user at the user computer if they did not respond to the prompt within the predefined period that they did not comply with the requirements to be credited with having paid attention to the advertisement.

The invention allows a new method of advertising with ability to ensure that television-style advertisements have been viewed in their entirety. This allows for permission-based advertising to be truly effective on the Internet, on a large scale. Because advertisers are assured that their advertisements have been actively viewed, users can “choose” to view long running, television-style advertisements, in return for valuable rewards in the form of information/services/goods.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a diagram of a user computer interfacing with a server with a storage of presentation information and control information that is accessed on a network, in accordance with example embodiments;

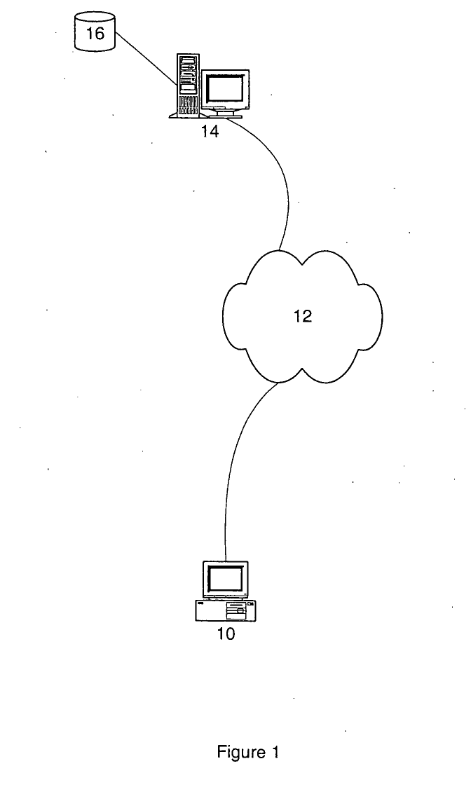

FIG. 2 is an example of advertising information using a Shockwave tool developed by Macromedia including presentation information and control information, in accordance with example embodiments;

FIG. 3 is a flow chart showing the operation of a control program, in accordance with example embodiments; and

FIG. 4 is a flow chart of a prompt display routine which commences with an initialized routine, in accordance with example embodiments.

### BEST MODE(S) FOR CARRYING OUT THE INVENTION

The embodiment will be described with reference to the presentation of advertisements to a user via computer network, such as the Internet. However, it should be appreciated that the invention may be utilised with other forms of information. Further, it would be readily appreciated that other means of delivering the advertisement to the user may also be used.

In the embodiment, a user appliance in the form of a user's computer 10, together with a presentation device 11 is connected to the Internet 12 in known manner. A server 14 is also connected to the Internet 12. The server 14 includes a store 16 of advertisement information, user registration information including credits awarded to each user, and advertising frequency and scheduling information that is derived from payments and advertising contracts undertaken by advertisers.

Advertisement information is provided in the store 16 for each advertisement. The advertisement information comprises presentation information which is used to recreate the advertisement for presentation to a user, and control information which is used to determine whether the user paid attention to the advertisement during the presentation. In the embodiment, the control information is used to determine when prompts will be presented to the user during the presentation of the advertisement, and to determine whether the user provided a desired response within an allowable time. The prompt may be audible or visual in nature, or a combination of both. If the user does not provide the desired response within the allowable time, it is inferred that the user was not paying attention to the advertisement, and the user is not credited with having paid attention to the advertisement, as described in more detail below.

The advertisement defined by the advertisement information in the embodiment is preferably a television-style advertisement, in order to better retain the user's interest. By providing a defined start and stop time, the presentation is a short burst to the user, in return for which the user is expected to pay complete attention.

In the embodiment, the control information comprises:
Prompt media information that includes the audio and/or visual information regarding the prompt to be presented to the user;
A minimum and maximum number of times the prompt will be presented to the user during the presentation of the advertisement;
The minimum delay between the presentation of adjacent prompts;
The minimum and maximum period of time each prompt is presented to the user;
The desired response from the user;
Zone information defining the regions within which the prompt may be presented to the user. The zone information may be inclusive or exclusive. That is, the zone information may define regions where the prompt is allowed to be presented, or it may define regions in which the prompt may not be presented. This allows the advertiser a degree of flexibility by ensuring that the prompt will not interfere with the primary advertising information. In this regard, the zone information may also consist of times within the presentation of the advertisement that the prompt may or not be presented, and/or areas within a display where the prompt may or not be presented in the case of a visual prompt.

In alternative embodiments a subset of the above control information.

It should be appreciated that some of the control information may be dynamically generated by the server 14 to prevent users from adapting to the prompts in advertisements. In particular, the minimum and maximum number of times the prompt will be presented to the user may be dynamically generated by the server 14 each time advertisement information is sent to a users computer 10 within predefined ranges.

When a user wishes to view advertisements, they initiate an advertisement presentation using an appropriate command to their computer 10, such as by clicking an icon or activating a menu command. The computer 10 then obtains the advertisement information for the advertisement from the server 14. In this regard, the server 14 distributes advertisement information to the users computer 10 in accordance with scheduling information that is derived from payments and advertising contracts undertaken by advertisers. The advertisement information may be distributed to the users computer 10 in advance and cached, or it may be provided on demand.

In alternative embodiments, the presentations may be commenced without the user initiating them.

The computer 10 presents the advertisement to the user according to the presentation information contained in the advertisement information received from the server 14. In the embodiment, the advertisement may include video and/or audio as well as static visual information. It is preferred that the advertisement occupies the entire display of the computer 10 for maximum effect.

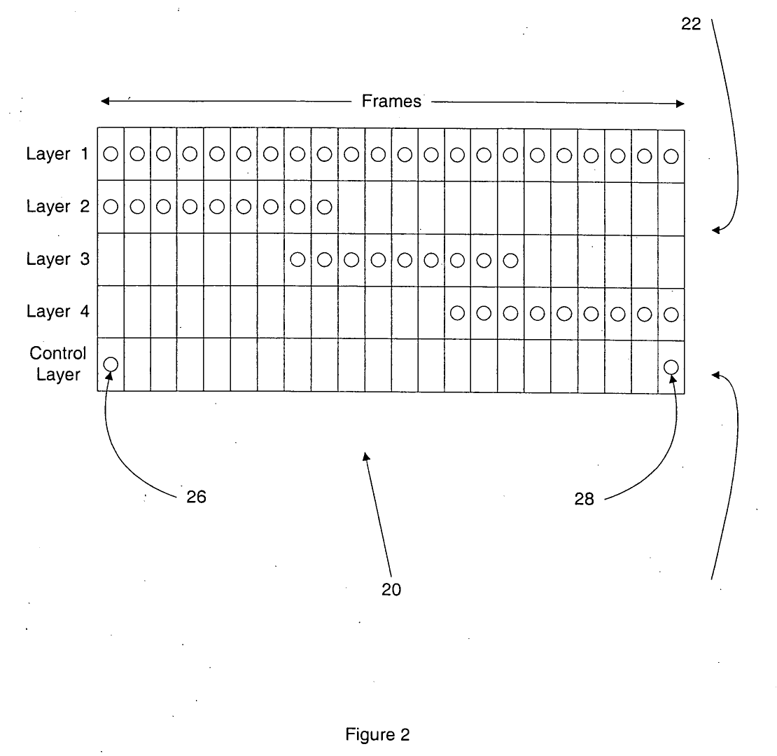

FIG. 2 shows an example of advertising information using Shockwave tool developed by Macromedia. The advertisement information comprises presentation information 22 and control information 24.

The presentation information 22 comprises four layers of information labelled layer 1 to layer 4. Each layer may relate to audio and/or visual information that is to be presented to the user at prescribed frames of the advertisement. In the example shown in FIG. 2, the frames correspond with the columns shown in the drawing.

Information in each layer for a particular frame is represented by a circle within each layer. Thus, it can be seen that layer 1 includes information for the entire advertisement, layer 2 includes information that will be presented simultaneously with layer 1 at the commencement of the presentation, layer 3 includes information that will be presented in the middle of the advertisement and which overlaps with information at the end of layer 2, and layer 4 includes information that would be presented at the end of the advertisement and which overlaps with layer 3.

The control information 24 consists of a single layer labelled control layer in FIG. 2. The control layer includes a control program 26 that is placed in the first frame of the advertisement information and a termination program 28 that is contained in the last frame of the advertisement information. Thus, when the advertisement is presented to the user, the control program 26 is executed at the commencement of the presentation.

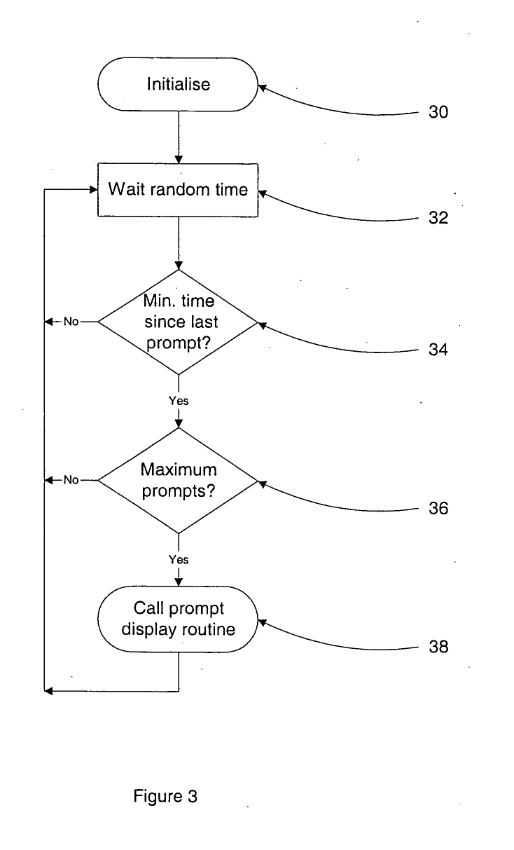

FIG. 3 is a flow chart showing the operation of the control program 26. The control program 26 firstly performs an initialisation at 30. This includes seeding a number generator that will be used to determine when prompts will be presented to the user. As is known in the art, a seed number is the initializing number in a random number generator process. This seed number is used by a random number generator to compute a sequence of apparently random results via an algorithm that uses the seed as its initial variable.

Also, the initialised routine 30 determines a probability for a prompt to be presented to the user at any given frame within the advertisement, having regard to the total number of frames within the advertisement, and the permissible times when prompts may be presented to the user defined by the zone information, and the minimum and maximum number of advertisements to be presented to the user.

Next, the control program 26 waits a random time at 32. This may be achieved in a number of ways, however in the embodiment it is achieved by assigning a probability that a prompt will be presented in each given frame, and determining during each frame whether to present prompt in accordance with that probability.

When the control program 26 determines that a prompt should be presented, a check is performed at 34 as to whether the minimum time has elapsed since the previous prompt was presented. If the minimum time has not elapsed, program control returns to the waiting routine at 32.

If the minimum time since the last prompt has elapsed, a check is then performed at 36 as to whether the maximum number of prompts has already been presented during the advertisement. If the maximum number of prompts has already been presented, program control returns to the wait function at 32, otherwise the prompt display routine is called at 38.

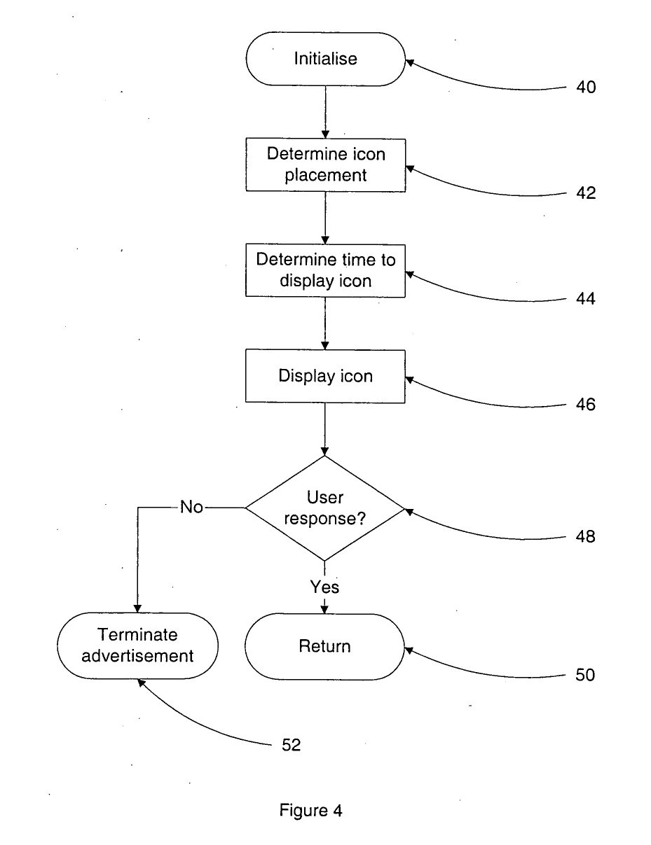

A flow chart of the prompt display routine is shown in FIG. 4, which commences with an initialised routine 40. Next, the prompt display routine determines the placement of the icon in the event that a visual prompt is used at 42. This is achieved by generating a random location for the position of the prompt having regard to any included or excluded zones contained in the zone information.

Next, the prompt display routine determines the period of time for which the prompt will be presented at 44 having regard to the minimum and maximum presentation times in the control information, following which the prompt is presented at 46.

The prompt display routine then determines whether a desired users response was provided whilst the prompt was presented at 48. If the user provided a desired response, program control returns to the control program at 50, otherwise the presentation of the advertisement is terminated at step 52 and the user is informed that they did not comply with the requirements to be credited with having paid attention to the advertisement.

The nature of the desired response from the user can be any desired response, such as pressing a pre-defined key, clicking a mouse button or a more advanced responses such as clicking the mouse button with the cursor placed over the location of the prompt icon, or pressing a key which corresponds with the letter shown in the display icon on the screen. To assist the user in identifying the display icon, the display icon may be flashing or otherwise animated to attract the users attention.

The prompt display routine will terminate the presentation of the advertisement if the user does not provide the desired response each time a prompt is presented to the user. Thus, the termination routine 28 contained in the last frame of the advertisement will only be executed with the user response to all prompts that are presented throughout the presentation of the advertisement. The termination routine 28 communicates with the server 14 to indicate that the user responded to all the prompts presented during the advertisement, in response to which the server 14 credits that user's information in the store 16 with having paid attention to the advertisement.

It is also envisaged that the user may respond to the advertisements he or she viewed and/or heard whilst paying attention to the advertisement presentation. Typically, such responses may include clicking a mouse button within the advertisement while pressing a pre-defined key to indicate that he or she desires further information concerning that advertisement. In the embodiment, it is preferred that the computer 10 continues to present the advertisement to the user and displays further information concerning the advertisement once the entire advertisement has presented to the user. In the embodiment, the control information may include an Internet URL relating to the advertisement, and the termination routine 28 will launch a web browser and direct it to the URL contained in the control information to provide the user with further information.

By crediting users with having paid attention to advertisements only if all prompts that are presented at random times and at locations throughout the advertisement are responded to, users are not able to obtain credit for paying attention to advertisements unless the user pays attention throughout the presentation of the advertisement. Thus, the embodiment provides a greater degree of security to advertisers that their advertisements are being observed. Randomly placing the prompt within the advertisement prevents a user from placing their cursor over the known location of the prompt and clicking their mouse button repeatedly while looking away in order to be falsely credited for paying attention to the entire advertisement. Presenting prompts at random times throughout the advertisement prevents the user from paying attention only when they know a prompt is about to be presented.

The embodiment has been described with reference to the presentation information and the control information being sent to the user's computer. However, in other embodiments, it may be desirable for the server 14 to process the presentation information and the control information. The server 14 would then present the resultant advertisement including any prompts to the user and would receive any responses from the user's computer or other appliance in order to determine whether a desired response was given. Such an embodiment would be ideally suited for situations where the appliance used by the user has limited functionality, such as a telephone. Thus, the server 14 may analyse the presentation information and the control information and deliver an audio advertisement containing audible prompts to the user and may analyse any tones generated by the user pressing keys on their telephone in order to determine whether a desired response has been provided.

Further, although the embodiment has been described with reference to the advertisement information being distributed by the server 14 via the Internet, it should be appreciated that in other embodiments, the advertising information may be embedded on a suitable media, such as a digital versatile disc (DVD).

Further, it is envisaged that the invention may be used with digital television, or any other user appliance capable of appropriate user interaction. It should be appreciated that the scope of this invention is not limited to the particular embodiment described above.

1. A system for presenting information over time to a user, comprising:
a processor arranged to store presentation information and control information;
a user display appliance responsive to the presentation information to produce a presentation and deliver the presentation over time to the user;
said user display appliance further responsive to the control information to visually present at least one prompt to the user at at least one point in time during the presentation;
said user display appliance arranged to communicate to the processor whether a desired response, in response to the prompt, was received from the user within a predefined period during and/or after each prompt;
said processor arranged to credit the user with having paid attention to the presentation over time upon being notified by the user display appliance that the desired response, in response to the prompt, was received within the predefined period; and
wherein said user display appliance arranged to notify the user that they did not comply with the requirements to be credited with having paid attention to the advertisement upon the user display appliance determining that the desired response was not received from the user within the predefined period.

2. The system of claim 1, wherein said prompt is a visual icon, and said user display appliance is arranged to overlay said icon on said presentation.

3. The system of claim 1, wherein the at least one prompt is presented at a random point in time during the presentation, and the random point in time is determined based on a random number generator included in the control information.

4. The system of claim 1, wherein said control information includes zone information defining at least one first region where said prompt can be placed, said user display appliance arranged to place said prompt within one of said first regions.

5. The system of claim 1, wherein said control information includes zone information defining at least one second region where said prompt can not be placed, said user display appliance arranged to place said prompt in a position that is not within any of said second regions.

6. The system of claim 1, wherein the control information includes minimum delay information, said user display appliance arranged to provide a delay between adjacent prompts presented during the presentation that is not less than said minimum delay information.

7. The system of claim 1, wherein said control information includes a minimum and maximum presentation time for each prompt, said user display appliance arranged to randomly determine, based on a random number generator, a presentation time for each prompt between said minimum and maximum presentation time.

8. The system of claim 7, where said predefined period comprises the presentation time for each prompt.

9. The system of claim 1, wherein said processor is arranged to dynamically generate at least a portion of said control information.

10. The system of claim 9, wherein said processor is arranged to dynamically generate minimum and maximum presentation time for each prompt.

11. The system of claim 1, whereby said presentation is terminated upon notifying the user that they did not comply with the requirements to be credited with having paid attention to the advertisement.

12. A computer-readable medium having computer software stored thereon, the computer software arranged, when executed in a computer to perform method steps for presenting information over time to a user on a user display appliance, the method steps comprising:
presenting said information over time to the user on the user display appliance;
presenting a visual prompt to the user on the user display appliance at least one point in time during the presentation of said information;
determining whether a desired response, in response to each prompt, is received from the user within a predefined period during and/or after each prompt;
crediting the user with having paid attention to the information only if the user provides all desired responses, in response to the prompt; and
notifying the user that they did not comply with the requirements to be credited with having paid attention to the advertisement if a desired response is not received from the user within the predefined period during and/or after each prompt.

13. The computer software of claim 12, wherein said step of providing a prompt comprises overlaying said prompt on said information.

14. The computer software of claim 12, wherein said at least one point in time is randomly determined based on a random number generator.

15. The computer software of claim 12, wherein said method steps further comprise the step of defining at least one first region where said prompt can be placed, and said step of providing a prompt comprises placing said prompt within one of said first regions.

16. The computer software of claim 12, wherein said method steps further comprise the step of defining at least one second region where said prompt can not be placed, and said step of providing a prompt comprises placing said prompt in a position that is not within any of said second regions.

17. The computer software of claim 12, wherein said method steps further comprise the step of providing a minimum delay between adjacent prompts during the presentation.

18. The computer software of claim 12, wherein said method steps further comprise the step of providing a minimum and maximum presentation time for each prompt, and said step of providing a prompt comprises providing said prompt during the presentation for a random time, based on a random number generator, said random time between said minimum and maximum presentation time.

19. The computer software of claim 18, where said predefined period comprises the presentation time for each prompt.

20. The computer software of claim 12, wherein the desired response comprises the user moving a cursor over said prompt and pressing a button.

21. The computer software of claim 12, wherein said method step of notifying the user that they did not comply with the requirements to be credited with having paid attention to the advertisement includes terminating said presentation.

22. A computer-implemented method for ensuring that a user pays attention to an advertisement, the method comprising the steps of:
receiving, at a user computer, presentation information and control information, the presentation information including the advertisement;
presenting the advertisement to the user at the user computer in accordance with the presentation information;
at the user computer and in accordance with the control information, outputting at least one visual prompt during the presentation of the advertisement to the user;
at the user computer, enabling the user to respond to the at least one prompt within a predefined period while the advertisement is presented to the user to signify that the user paid attention to the advertisement;
communicating the response of the user, in response to the prompt, to a remote server; and
notifying the user at the user computer that they did not comply with the requirements to be credited with having paid attention to the advertisement if they did not respond to the prompt within the predefined period.

23. The method of claim 22, further comprising the steps of:
receiving the response of the user at the remote server; and
allocating a reward to the user if the response signifies that the user paid attention to the advertisement.
